(19) United States
(12) Patent Application Publication
(10) Pub. No.: US 2026/0211518 A1
(43) Pub. Date: Jul. 23, 2026

(54) TOUCHPAD DEVICE

(71) Applicant: TPK Glass Solutions ( Xiamen ) Inc., Xiamen (CN)

(72) Inventors: Cai-Jin YE, Xiamen City (CN); Tsai-Kuel WEI, Hsinchu County (TW); Wei-Yi LIN, Taoyuan City (TW); Chen-Hsin CHANG, Taoyuan City (TW); Tai-Shih CHENG, Taipei City (TW)

(21) Appl. No.: 19/446,254

(22) Filed: Jan. 12, 2026

(30) Foreign Application Priority Data
Jan. 17, 2025 (CN) 202510077358.2

(51) Int. Cl. G06F 3/041; G06F 3/01; G06F 3/044

(52) U.S. Cl. CPC G06F 3/0414; G06F 3/016; G06F 3/044

(57) ABSTRACT

A touchpad device includes a cover plate, a circuit board, a bonding layer, a plurality of force sensing units, and a feedback assembly. The circuit board is disposed under the cover plate and has a first surface facing the cover plate and a second surface away from the cover plate. The bonding layer is disposed between the cover plate and the first surface and includes a bonding portion and at least one hollow portion. The force sensing unit is disposed on the second surface. Each of the force sensing units includes a plurality of strain electrodes and a plurality of temperature compensation electrodes adjacent to each other. The strain electrodes are disposed corresponding to the bonding portion and the hollow portion. The temperature compensation electrodes are disposed corresponding to the bonding portion or the hollow portion. The feedback assembly is disposed on the second surface and provides tactile feedback.

### CROSS-REFERENCE TO RELATED APPLICATION

This application claims priority to China Patent Application No. 202510077358.2, filed Jan. 17, 2025, which is incorporated herein by reference.

### FIELD OF DISCLOSURE

The present disclosure relates to a touchpad device.

### DESCRIPTION OF PRIOR ART

The current development trend of touchpad devices is the advancement from simply a touch function to an integration of touch, force sensing, and tactile feedback. A touchpad device of the prior art installs a force sensor on an elastic component (such as a metal frame) and mounts the elastic component to a touch printed circuit board. One such example is described in China Patent Application No. 107025017B. However, the disadvantages of these devices of the prior art include a large number of elements, complex assembly processes, higher overall costs, and generally more thickness.

Therefore, to provide a touchpad device that can solve the aforementioned problems is a major focus that the industry invests its research and development resources in.

### SUMMARY

In view of this, one objective of the present disclosure is to provide a touchpad device that can solve the aforementioned problems.

To achieve the aforementioned objective, a touchpad device comprises a cover plate, a circuit board, a bonding layer, a plurality of force sensing units, and a feedback assembly according to one embodiment of the present disclosure. The circuit board is disposed under the cover plate and comprises a first surface facing the cover plate and a second surface away from the cover plate. The bonding layer is disposed between the cover plate and the first surface and comprises a bonding portion and at least one hollow portion. The force sensing unit is disposed on the second surface. Each of the force sensing units comprises a plurality of strain electrodes and a plurality of temperature compensation electrodes adjacent to each other. The strain electrodes are disposed corresponding to the bonding portion and the hollow portion at a same time in an arrangement direction of the cover plate and the bonding layer. The temperature compensation electrodes are disposed corresponding to one of the bonding portion or the at least one hollow portion in the arrangement direction. The feedback assembly is disposed on the second surface and configured to provide tactile feedback.

In one or several embodiments of the present disclosure, the hollow portion is closed slot.

In one or several embodiments of the present disclosure, a quantity of the hollow portion is a plurality. The hollow portions are disposed corresponding to the force sensing units in the arrangement direction, respectively.

In one or several embodiments of the present disclosure, a quantity of the hollow portion is a plurality. Each of the hollow portions is disposed corresponding to a plurality of the force sensing units in the arrangement direction.

In one or several embodiments of the present disclosure, the touchpad device further comprises a supporting member and a plurality of elastic members. The supporting member is disposed under the circuit board. The elastic members are disposed between the circuit board and the supporting member.

In one or several embodiments of the present disclosure, the elastic members are disposed corresponding to the hollow portion in the arrangement direction.

In one or several embodiments of the present disclosure, the feedback assembly comprises a coil layer and a magnet set.

In one or several embodiments of the present disclosure, the coil layer is disposed on the circuit board. The magnet set is disposed on the supporting member.

In one or several embodiments of the present disclosure, the feedback assembly is a linear resonant actuator.

In one or several embodiments of the present disclosure, the strain electrodes and the temperature compensation electrodes of each of the force sensing units form a bridge circuit.

In summary, since the force sensing units of the touchpad device of the present disclosure comprise both strain electrodes and temperature compensation electrodes at the same time, there is a built-in temperature compensation function in solving the detection bias caused by the heat effect. By means of having the strain electrodes disposed corresponding to the bonding portion of the bonding layer and the hollow portion in the arrangement direction of the cover plate and the bonding layer (that is, crossing the bonding portion and the hollow portion), the deformation amount of the strain electrodes will increase when the cover plate of the touchpad device is pressed, leading to an increase in sensitivity. By means of having the temperature compensation electrodes disposed corresponding to the bonding portion or the hollow portion in the arrangement direction of the cover plate and the bonding layer (that is, not crossing the bonding portion and the hollow portion), strain will be prevented, so that temperature changes can be provided precisely for reference.

The aforementioned statements are used to explain problems that can be solved by the present disclosure, the technical means for solving the problems, and the effect thereof. The present disclosure will become better fully understood from the detailed descriptions given herein below by way of embodiments with reference to the accompanying figures.

### BRIEF DESCRIPTION OF THE FIGURES

To better understand the aforementioned and other objectives, novel features, advantages, and embodiment examples of the present disclosure, relevant figures are provided as follows.

FIG. 1 is a schematic figure of an electronic device according to an embodiment of the present disclosure.

FIG. 2 is a cross-sectional schematic figure of the touchpad device of FIG. 1.

FIG. 3 is a schematic figure of a top view of some elements of the touchpad device of FIG. 2.

FIG. 4 is a schematic figure of the touch electrode layer of the touch sensing member of FIG. 2.

FIG. 5 is a partially enlarged schematic figure of the first touch electrode layer of FIG. 4.

FIG. 6 is another partially enlarged schematic figure of the first touch electrode layer of FIG. 4.

FIG. 7 is a block figure of functions according to the touch sensing member of an embodiment of the present disclosure.

FIG. 8 is a cross-sectional schematic figure of the circuit board of FIG. 2.

FIG. 9 is a schematic figure of a top view of the coil layer and the magnet set of an embodiment of the present disclosure.

FIG. 10 is a schematic figure of a top view of the coil layer and the magnet set of another embodiment of the present disclosure.

FIG. 11 is a cross-sectional schematic figure of the touchpad device of another embodiment of the present disclosure.

FIG. 12 is a schematic figure of a top view of some elements of the touchpad device of FIG. 11.

FIG. 13 is an enlarged schematic figure of the area M of FIG. 12.

FIG. 14 is an enlarged schematic figure of the area M of FIG. 12 of another embodiment.

FIG. 15 is a circuit schematic of the force sensing unit of FIG. 12.

FIG. 16A is an enlarged schematic figure of the area M of FIG. 12 of the first comparative example.

FIG. 16B is an enlarged schematic figure of the area M of FIG. 12 of the second comparative example.

FIG. 16C is an enlarged schematic figure of the area M of FIG. 12 of the third comparative example.

FIG. 16D is an enlarged schematic figure of the area M of FIG. 12 of the fourth comparative example.

FIG. 17 illustrates is a pressure output signal of the touchpad device having the designs of the embodiment example of FIG. 13, the first comparative example, the second comparative example, the third comparative example, and the fourth comparative example, respectively.

### DETAILED DESCRIPTION

A plurality of embodiments of the present disclosure will be disclosed below with reference to the figures. For the purpose of clear illustration, many details in practice will be described together with the following descriptions. However, these detailed descriptions in practice shall not be interpreted to limit the present disclosure in any way. That is, in several embodiments of the present disclosure, these details in practice are not necessarily required. Furthermore, for the purpose of simplifying the figures, some structures and components of the prior art shown in the figures will be illustrated schematically.

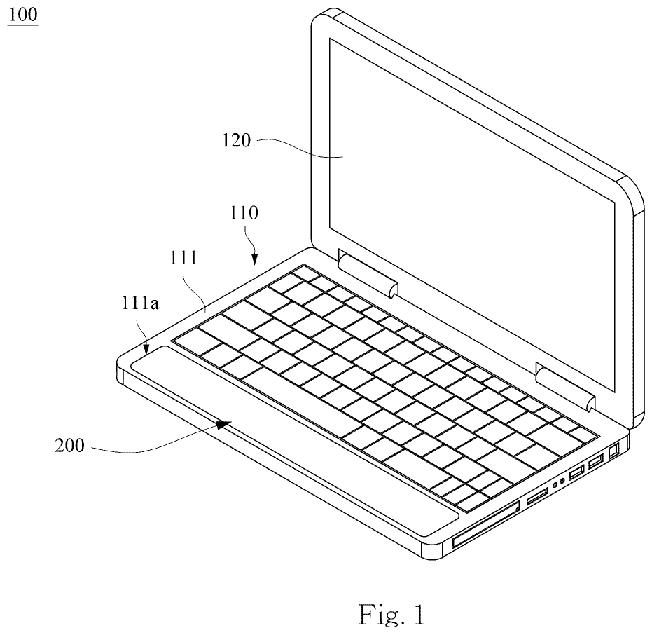

Please refer to FIG. 1, which is a schematic figure of an electronic device 100 according to an embodiment of the present disclosure. As illustrated in FIG. 1, in the embodiment, the electronic device 100 comprises a host computer 110, a display 120, and a touchpad device 200. The touchpad device 200 is disposed within the host computer 110, and is exposed to the outside from the recessed groove 111a of the casing part 111 of the host computer 110. The touchpad device 200 is an input device of the host computer 110 that is disposed therewithin, but the arrangement is not limited to such in the present disclosure. Furthermore, the touchpad device 200 is a rectangular area, consisting of a length and a width, wherein the width W can be adjusted (to such as a long strip as shown in FIG. 1) according to the design of different models, while the size is not limited to that shown in FIG. 1. In actual applications, the touchpad device 200 can be an electronic product using a touchpad as an input or operational interface (such as, personal digital assistant, keyboard having a touchpad, etc.). In other words, the concept of the touchpad device 200 of the present disclosure can be applied to any electronic product that uses a touchpad as an input or operational interface. Details of the touchpad device 200, including the structure and functions of some elements thereof, and connections and the actuation relationship among these elements, will be provided below.

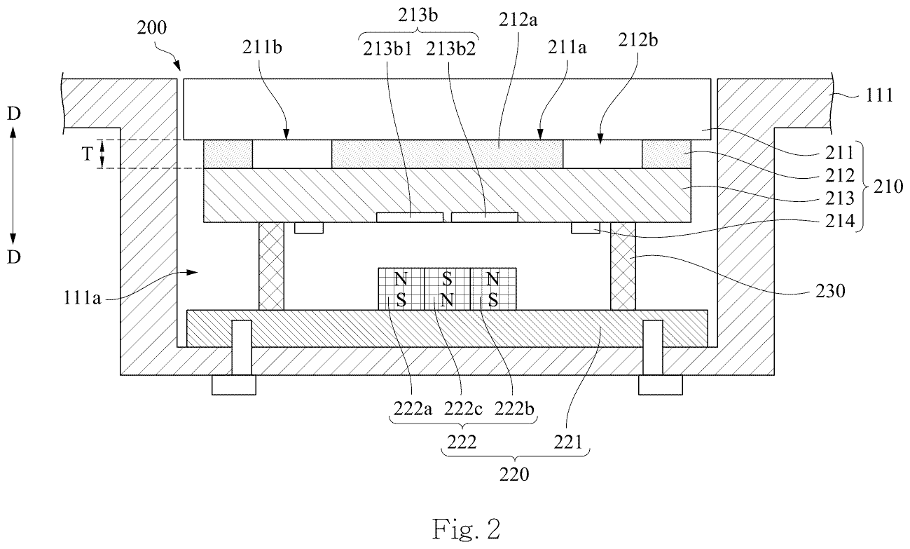

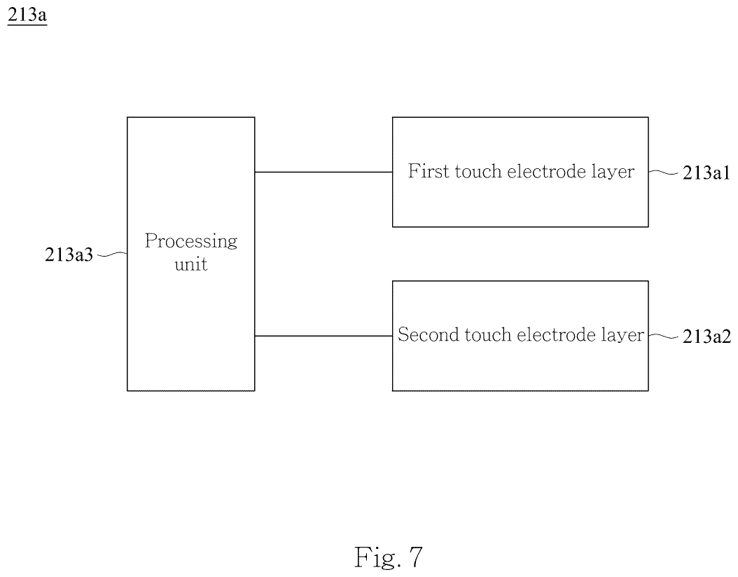

Please refer to FIG. 2, which is a cross-sectional schematic figure of the touchpad device 200 of FIG. 1. As in the embodiment illustrated in FIG. 2, the touchpad device 200 comprises a first assembly 210, a second assembly 220, and a plurality of elastic members 230. The first assembly 210 comprises a cover plate 211, a bonding layer 212, and a circuit board 213. The cover plate 211 has a bonding area 211a and a non-bonding area 211b. The bonding layer 212 is disposed under the cover plate 211 and has a bonding portion 212a corresponding to the bonding area 211a, and a plurality of hollow portions 212b corresponding to the non-bonding area 211b. The circuit board 213 is disposed under the bonding layer 212 and comprises a touch sensing member 213a (in reference to FIG. 7) and a coil layer 213b. The second assembly 220 comprises a supporting member 221 and a magnet set 222 disposed on the supporting member 221. The supporting member 221 is fixed to the bottom surface of the recessed groove 111a of the casing part 111 (for example, using screws), wherein the recessed groove 111a is located on the outer surface of the casing part 111. The elastic members 230 are disposed between the first assembly 210 and the second assembly 220. The magnet set 222 disposed on the supporting member 221 and the coil layer 213b disposed on the circuit board 213 constitute a vibration module. The elastic members 230 are configured to reduce vibration noise and effectively release vibration stress in the vertical direction.

For example, the bonding area 211a of the cover plate 211 can be defined as the area of the bottom surface of the cover plate 211 that is bonded with the bonding portion 212a of the bonding layer 212. The non-bonding area 211b of the cover plate 211 can be defined as the area of the bottom surface of the cover plate 211 that is not bonded with the bonding portion 212a of the bonding layer 212 (which corresponds to the hollow portions 212b). However, the present disclosure is not limited thereto.

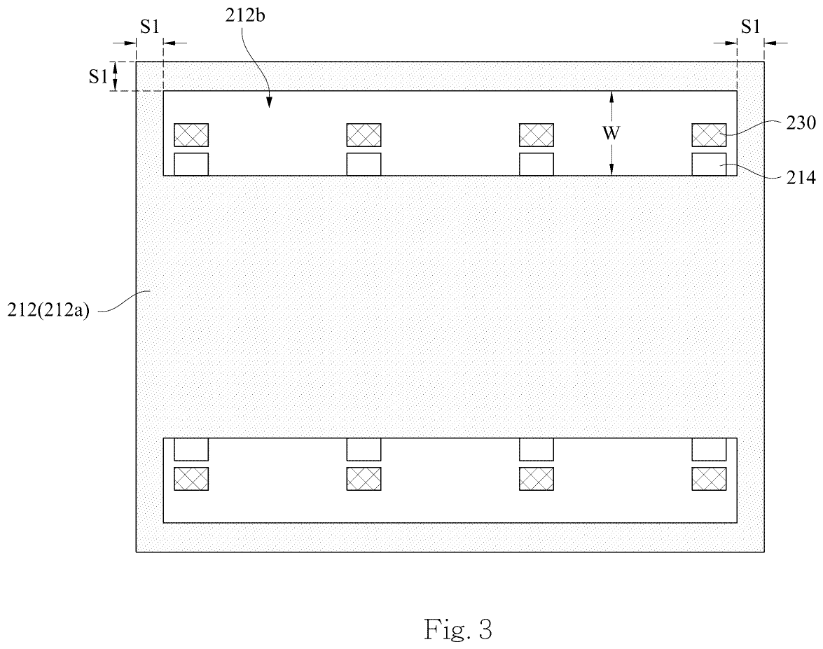

Please refer to FIG. 3, which is a schematic figure of a top view of some elements of the touchpad device 200 of FIG. 2. In the embodiment as illustrated in FIG. 2 and FIG. 3, the hollow portion 212b is a closed slot. However, the present disclosure is not limited thereto. The elastic members 230 are disposed corresponding to the hollow portion 212b in an arrangement direction D of the cover plate 211 and the bonding layer 212. One thing to be noted is that by configuring the hollow portions 212b on the bonding layer 212 disposed between the cover plate 211 and the circuit board 213 and by disposing the elastic members 230 acting as the supporting points to correspond to the hollow portions 212b in an arrangement direction D of the cover plate 211 and the bonding layer 212, the touchpad device 200 can respond better to vertical vibrations in deformation, thus achieving the effect of strengthening the vertical vibration haptics.

In several embodiments, the material of the bonding layer 212 comprises Pressure Sensitive Adhesive (PSA). However, the present disclosure is not limited thereto.

In several embodiments, as shown in FIG. 2, the bonding layer 212 has a thickness T of approximately 50 μm to approximately 500 μm. If the thickness T of the bonding layer 212 is smaller than 50 μm, the bonding layer 212 will not provide a sufficient compression level when users press the cover plate 211. If the thickness T of the bonding layer 212 is larger than 500 μm, the bonding layer 212 will affect the touch sensing member 213a (in reference to FIG. 7) in generating detection capacitance signals.

In several embodiments, the Young's modulus of the elastic member 230 is in range of 0.55 MPa to 0.8 MPa. Elastic members 230 having a Young's modulus within the aforementioned range can effectively reduce noise and release vibration stress in the vertical direction.

In several embodiments, the material of the elastic member 230 can be silicone However, the present disclosure is not limited thereto.

In several embodiments, the supporting member 221 is a silicon steel plate. The silicon steel plate has a permeability effect that can constrain the magnetic field from divergence, so that the magnetic field is more concentrated, making the magnetic field lines more concentrated within the same space.

In the embodiment as shown in FIG. 3, one of the hollow portions 212b (for example, the upper hollow portion 212b) is adjacent to the edge of the bonding layer 212 (for example, the upper edge of the bonding layer 212) with a gap distance S1, and the distance S1 is larger than approximately 2 mm. By limiting the range of the distance S1 between the hollow portion 212b and the adjacent edge of the bonding layer 212 according to the aforementioned value, the problem of the bonding layer 212 failing to hold firmly onto the cover plate 211 can be prevented. In addition, the gap distance between the upper hollow portion 212b and the right adjacent edge or left adjacent edge of the bonding layer 212 can be set as the aforementioned distance S1 as shown in FIG. 3. The gap distance between the lower hollow portion 212b and the lower adjacent edge, or left adjacent edge, or right adjacent edge of the bonding layer 212 can be set as the aforementioned distance S1 as shown in FIG. 3.

In the embodiment as shown in FIG. 3, one of the hollow portions 212b (for example, the upper hollow portions 212b) has a width W. The width W is larger than approximately 10 mm. By limiting the range of the width W of the hollow portion 212b according to the aforementioned value, the problem of the bonding layer 212 deforming too little during vibration can be prevented. More specifically, the hollow portion 212b has a shape of a long strip, wherein the aforementioned width W is the smaller dimension in the lateral direction of the hollow portion 212b. Relatively, the larger dimension in the lateral direction of the hollow portion 212b is the length. The lower hollow portion 212b shown in FIG. 3 can also be set at the aforementioned width W.

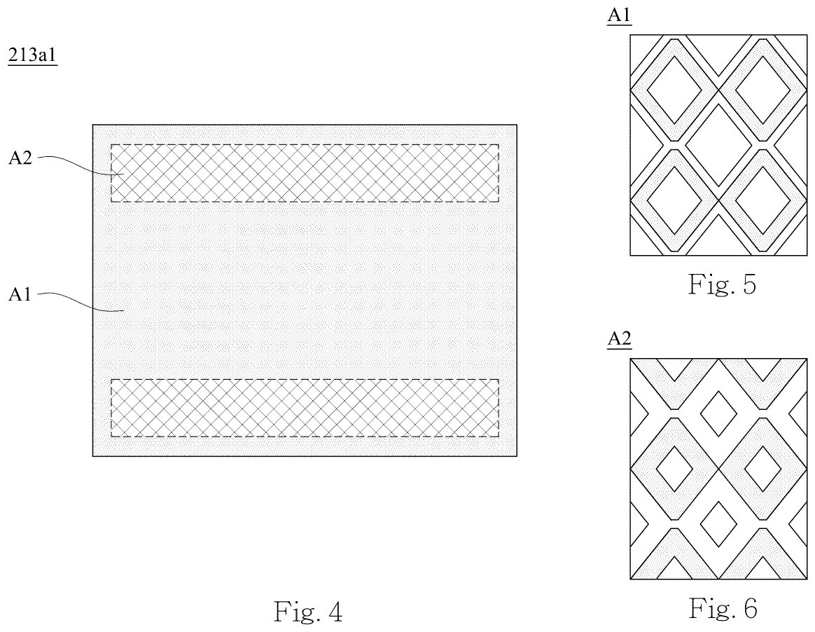

Please refer to FIG. 4, FIG. 5, and FIG. 6. FIG. 4 is a schematic figure of the touch electrode layer of the touch sensing member 213a of FIG. 2. FIG. 5 is a partially enlarged schematic figure of a first touch electrode layer 213a1 of FIG. 4. FIG. 6 is another partially enlarged schematic figure of the first touch electrode layer 213a1 of FIG. 4. In the embodiments as shown in FIG. 4 to FIG. 6, the touch sensing member 213a comprises the first touch electrode layer 213a1. The first touch electrode layer 213a1 has a first sensing area A1 and a second sensing area A2. The first sensing area A1 and the second sensing area A2 correspond to the bonding area 211a and the non-bonding area 211b respectively (that is, the second sensing area A2 corresponds to the hollow portion 212b) in an arrangement direction D (in reference to FIG. 2). The coil distance of the second sensing area A2 is larger than the coil distance of the first sensing area A1.

According to Gauss's law, the capacitance is proportional to the permittivity of the medium. Therefore, when users touch and perform controls on the cover plate 211, the touch sensing member 213a will produce differences between the bonding area 211a and the non-bonding area 211b in detection capacitance signals (since the permittivity of the bonding layer 212 is greater than the permittivity of the hollow portion 212b). The aforementioned differences result in the fact that when users tap on the bonding area 211a of the cover plate 211, the detection capacitance signals produced by the touch sensing member 213a are distinctively larger than the detection capacitance signals produced when users tap on the non-bonding area 211b of the cover plate 211. In the embodiment, by making the coil distance of the second sensing area A2 correspond to the hollow portion 212b larger than the coil distance of the first sensing area A1, the technological effect of compensating capacitance signal differences between the bonding area 211a and the non-bonding area 211b can be achieved by means of increasing the relevant areas. In other words, the touch sensing member 213a of the embodiment can compensate for the differences in detection capacitance signals by means of the magnetic pole structure.

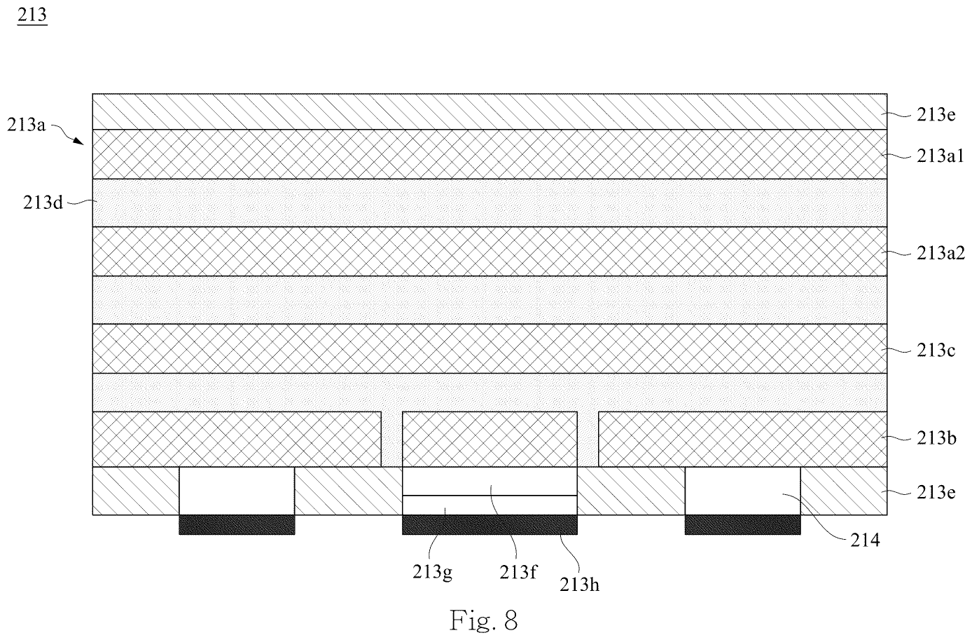

In several embodiments, the touch sensing member 213a further comprises a second touch electrode layer 213a2 (in reference to FIG. 8), and the second touch electrode layer 213a2 may also have areas identical or similar to the first sensing area A1 and the second sensing area A2 of the first touch electrode layer 213a1.

Please refer to FIG. 7, which is a block figure of functions according to the touch sensing member 213a of an embodiment of the present disclosure. In the embodiment as shown in FIG. 7, the touch sensing member 213a further comprises a processing unit 213a3. The processing unit 213a3 is electrically connected with the first touch electrode layer 213a1 and the second touch electrode layer 213a2, and the processing unit 213a3 is configured to produce detection capacitance signals corresponding to the touch/tap on the cover plate 211 by users detected by the first touch electrode layer 213a1 and the second touch electrode layer 213a2. Especially, the processing unit 213a3 is further configured to compensate for the differences in detection capacitance signals between the first sensing area A1 and the second sensing area A2. In other words, the touch sensing member 213a of the embodiment uses software methods to compensate for the differences in detection capacitance signals.

Please refer to FIG. 8, which is a cross-sectional schematic figure of the circuit board 213 of FIG. 2. In the embodiment as shown in FIG. 8, the circuit board 213 further comprises a shielding layer 213c. The first touch electrode layer 213a1, the second touch electrode layer 213a2, the shielding layer 213c, and the coil layer 213b are stacked in the order of top to bottom, and electrically insulated through the insulating layer 213d. The circuit board 213 further comprises two solder mask layers 213e. These two solder mask layers 213e are disposed on the upper and lower sides of the circuit board 213, respectively, and the two solder mask layers 213e cover and are in contact with the first touch electrode layer 213a1 and the coil layer 213b, respectively.

In the embodiment as shown in FIG. 8, the material of the coil layer 213b comprises copper. The circuit board 213 further comprises a nickel layer 213f. The nickel layer 213f covers the coil layer 213b. By means of covering the coil layer 213b with the nickel layer 213f thereon, the magnetic field lines generated by the magnet set 222 on the coil layer 213b can be concentrated effectively. In the embodiment, the circuit board 213 further comprises a metal layer 213g. The metal layer 213g covers the nickel layer 213f. By means of covering the nickel layer 213f with the metal layer 213g thereon, oxidation of the nickel layer 213f can be prevented. In the embodiment, the nickel layer 213f and the metal layer 213g are embedded in the solder mask layer 213e. The circuit board 213 further comprises a cover layer 213h that has an insulation function. The cover layer 213h covers the metal layer 213g to prevent the metal layer 213g from being exposed at the solder mask layer 213e.

In the embodiment as illustrated in FIG. 2 and FIG. 8, the first assembly 210 further comprises a plurality of force sensors 214. The force sensors 214 are disposed on the circuit board 213. The force sensors 214 are configured in response to the deformation of the circuit board 213 (for example, the ones caused by the cover plate 211 while being pressed by users) to generate force sensing signals. When the force sensors 214 produce force sensing signals, the processing unit 213a3, shown in FIG. 7, is configured to produce different vibration forces through the control of the vibration module based on the touch operations and force sensing signals, and then further provide the tactile feedback effect. Furthermore, as shown in FIG. 8, since the force sensors 214 are embedded in the solder mask layer 213e and the force sensors 214 are covered with a cover layer 213h, the force sensors 214 will not be exposed from the solder mask layer 213e.

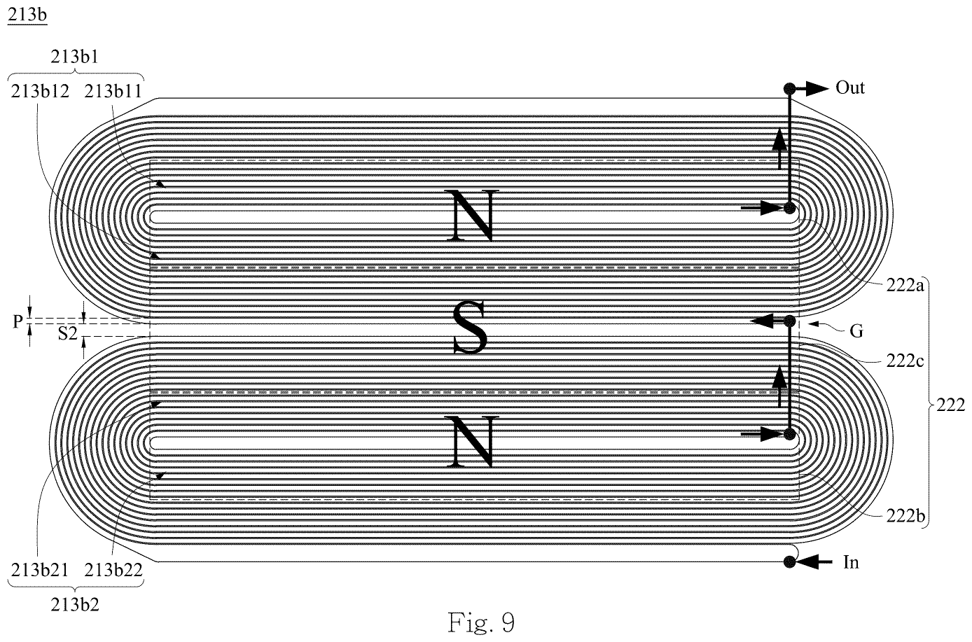

Please refer to FIG. 9, which is a schematic figure of a top view of the coil layer 213b and the magnet set 222 of an embodiment of the present disclosure. In the embodiment as shown in FIG. 9, the coil layer 213b comprises a first coil unit 213b1 and a second coil unit 213b2 that are connected. The first coil unit 213b1 and the second coil unit 213b2 can be electrically coupled to external controllers (not shown in the figure). By making the distance S2 between two coil units of a coil layer 213b essentially equal to the coil distance P of the coil units (that is, without keeping an assembly tolerance between the first coil unit 213b1 and the second coil unit 213b2), the area utilization rate of the circuit board 213 can be increased.

In the embodiment as shown in FIG. 9, along with FIG. 2, the magnet set 222 comprises a first magnet 222a, a second magnet 222b, and a third magnet 222c. The first magnet 222a has a first magnetic pole end, and the first magnetic pole end is facing the first coil unit 213b1 in the arrangement direction D (in reference to FIG. 2). The second magnet 222b has a second magnetic pole end, and the second magnetic pole end is facing the second coil unit 213b2 in the arrangement direction D. The third magnet 222c has a third magnetic pole end, and the third magnetic pole end is facing the gap G between the first coil unit 213b1 and the second coil unit 213b2 in the arrangement direction D. The third magnet 222c is disposed in parallel between the first magnet 222a and the second magnet 222b seamlessly. The polarity of the third magnetic pole end is different from the polarity of the first magnetic pole end and the polarity of the second magnetic pole end. In response to the aforementioned design of leaving no assembly tolerance between the first coil unit 213b1 and the second coil unit 213b2, through the arrangement of having two magnetic pole ends of two adjacent magnets of the magnet set 222 (that is, the first magnet 222a and the third magnet 222c, or the second magnet 222b and the third magnet 222c) with different polarities to face the first coil unit 213b1 and the second coil unit 213b2 respectively, these two magnets 222a, 222b can be disposed in parallel seamlessly.

More specifically, as illustrated in FIG. 9, the first coil unit 213b1 and the second coil unit 213b2 are produced by the same coil winding method and connected in series. The first coil unit 213b1 comprises two straight coil bundle sections, 213b11 and 213b12. The two straight coil bundle sections, 213b11 and 213b12, are aligned horizontally. The second coil unit 213b2 comprises two straight coil bundle sections, 213b21 and 213b22. The two straight coil bundle sections, 213b21 and 213b22, are aligned horizontally. The first magnet 222a is located below the straight coil bundle section 213b11 partially (in reference to the lower half portion of FIG. 9) and the straight coil bundle section 213b12 partially (in reference to the upper half portion of FIG. 9), and the polarity of the first magnetic pole end facing the straight coil bundle sections 213b11 and 213b12 is N pole. The second magnet 222b is located below the straight coil bundle section 213b21 partially (in reference to the lower half portion of FIG. 9) and the straight coil bundle section 213b22 partially (in reference to the upper half portion of FIG. 9), and the polarity of the second magnetic pole end facing the straight coil bundle sections 213b21, 213b22 is N pole. The third magnet 222c is located below the straight coil bundle section 213b12 partially (in reference to the lower half portion of FIG. 9), the straight coil bundle section 213b21 partially (in reference to the upper half portion of FIG. 9), and the gap G between the first coil unit 213b1 and the second coil unit 213b2; and the polarity of the third magnetic pole end facing the straight coil bundle sections 213b12, 213b21 is S pole. The electric current flows into the connecting point at the outer edge of the second coil unit 213b2 (located in the lower-right area of FIG. 9) and flows out from the connecting point at the inner edge of the second coil unit 213b2. Subsequently, the electric current flowing out from the second coil unit 213b2 then flows into the connecting point (through the wire at the bottom) at the outer edge of the first coil unit 213b1 (located in the center-right area of FIG. 9) and flows out from the connecting point (through the wire at the bottom) at the inner edge of the first coil unit 213b1. Through the aforementioned configuration, the magnet set 222 and the coil layer 213b are structured to be a vertical vibration module.

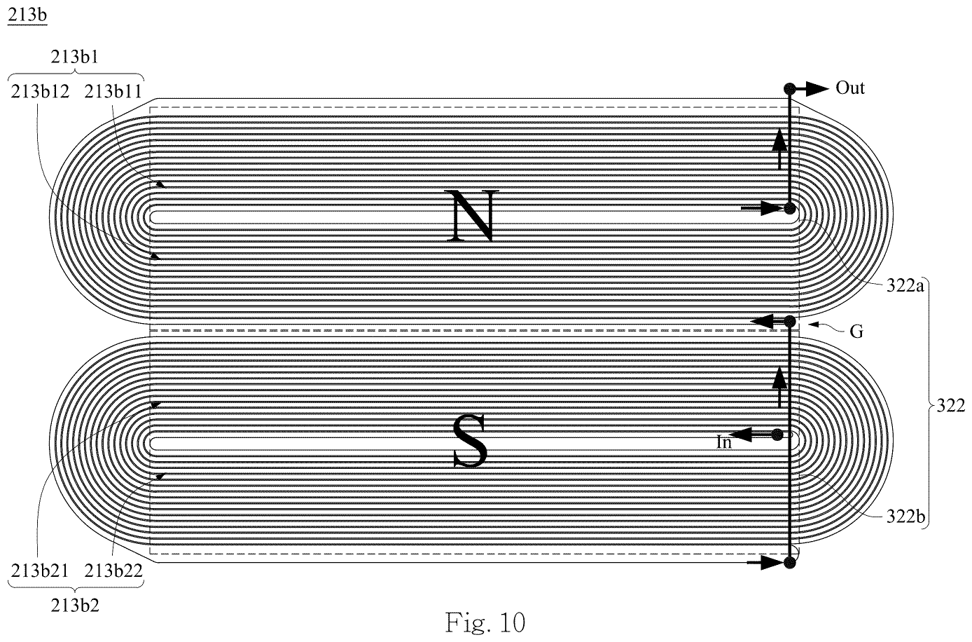

Please refer to FIG. 10, which is a schematic figure of a top view of the coil layer 213b and the magnet set 322 of another embodiment of the present disclosure. In the embodiment as shown in FIG. 10, the magnet set 322 comprises a first magnet 322a and a second magnet 322b. The first magnet 322a has a first magnetic pole end, wherein the first magnetic pole end is facing the first coil unit 213b1 in an arrangement direction D. The second magnet 322b has a second magnetic pole end, wherein the second magnetic pole end is facing the second coil unit 213b2 in an arrangement direction D. The first magnet 322a and the second magnet 322b are disposed in parallel seamlessly. The polarity of the first magnet pole end is different from the polarity of the second magnetic pole end. In response to the aforementioned design of leaving no assembly tolerance between the first coil unit 213b1 and the second coil unit 213b2, through the arrangement of having the magnetic pole ends of the first magnet 322a and the second magnet 322b in different polarities to face the first coil unit 213b1 and the second coil unit 213b2 respectively, the first magnet 322a and the second magnet 322b may be disposed in parallel seamlessly.

More specifically, as shown in FIG. 10, the first magnet 322a is located below the straight coil bundle sections, 213b11 and 213b12, and the polarity of the first magnetic pole end facing the straight coil bundle sections, 213b11 and 213b12, is N pole. The second magnet 322b is located below the straight coil bundle sections, 213b21 and 213b22, and the polarity of the second magnetic pole end facing the straight coil bundle sections, 213b21 and 213b22, is S pole. The electric current flows into the connecting point at the inner edge of the second coil unit 213b2 and flows out from the connecting point at the outer edge of the second coil unit 213b2 (located in the lower-right area of FIG. 10). Subsequently, the electric current flowing out from the second coil unit 213b2 then flows into the connecting point (through the wire at the bottom) at the outer edge of the first coil unit 213b1 (located in the center-right area of FIG. 10) and flows out from the connecting point (through the wire at the bottom) at the inner edge of the first coil unit 213b1. Through the aforementioned configuration, the magnet set 322 and the coil layer 213b are structured to be a vertical vibration module.

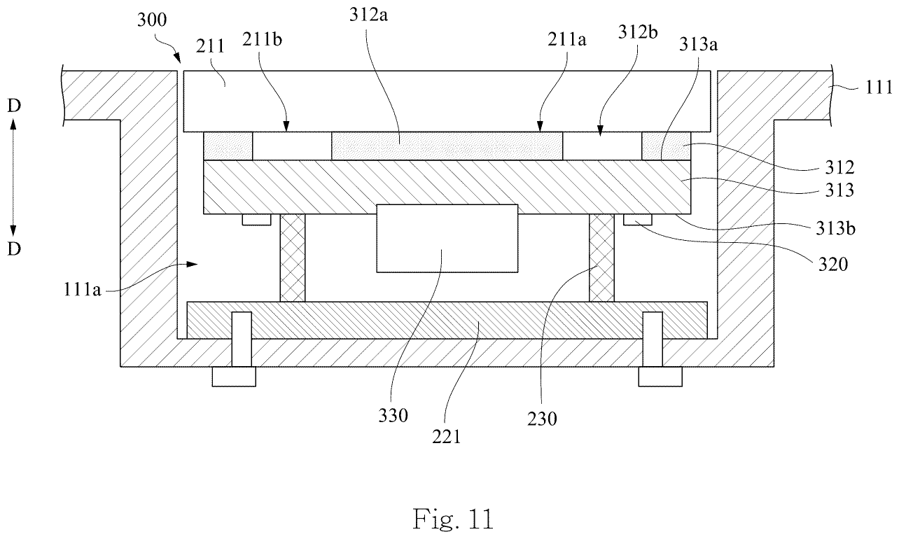

Please refer to FIG. 11, which is a cross-sectional schematic figure of the touchpad device 300 of another embodiment of the present disclosure. In the embodiment as shown in FIG. 11, the touchpad device 300 is disposed within the host computer 110 and is exposed to the outside from the recessed groove 111a of the casing part 111 of the host computer 110. The touchpad device 300 comprises the cover plate 211, a circuit board 313, a bonding layer 312, a plurality of force sensing units 320, a feedback assembly 330, a supporting member 221, and a plurality of elastic members 230, wherein the cover plate 211, the supporting member 221, and the elastic members 230 are the same as those of the embodiment described in FIG. 2. Therefore, relevant explanations of these components can be referenced in the aforementioned description. The cover plate 211 has a bonding area 211a and a non-bonding area 211b. The circuit board 313 is disposed under the cover plate 211 and comprises a first surface 313a facing the cover plate 211, and a second surface 313b away from the cover plate 211. The bonding layer 312 is disposed between the cover plate 211 and the first surface 313a, and the bonding layer 312 comprises a bonding portion 312a and a plurality of hollow portions 312b. The force sensing unit 320 is disposed on the second surface 313b. The force sensing units 320 are disposed corresponding to the bonding portion 312a and the hollow portions 312b at the same time in the arrangement direction D of the cover plate 211 and the bonding layer 312. The feedback assembly 330 is disposed on the second surface 313b and configured to provide tactile feedback. The supporting member 221 is disposed under the circuit board 313. The elastic members 230 are disposed between the circuit board 313 and the supporting member 221.

For example, the bonding area 211a of the cover plate 211 can be defined as the area of the bottom surface of the cover plate 211 that is bonded with the bonding portion 312a of the bonding layer 312. The non-bonding area 211b of the cover plate 211 can be defined as the area of the bottom surface of the cover plate 211 that is not bonded with the bonding portion 312a of the bonding layer 312 (corresponding to the hollow portions 312b). However, the present disclosure is not limited thereto.

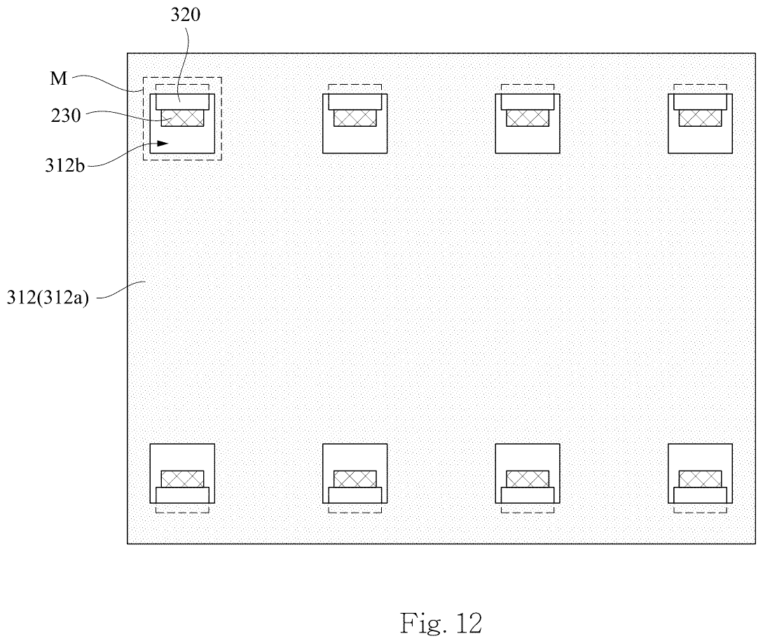

Please refer to FIG. 12, which is a schematic figure of a top view of some elements of the touchpad device 300 of FIG. 11. In the embodiment as illustrated in FIG. 11 and FIG. 12, the elastic members 230 are disposed in an arrangement direction D corresponding to the hollow portions 312b of the cover plate 211 and the bonding layer 312. One thing to be noted is that by configuring the hollow portions 312b on the bonding layer 312, disposed between the cover plate 211 and the circuit board 313, and by disposing the elastic members 230 as the supporting points in an arrangement direction D to correspond to the hollow portions 312b of the cover plate 211 and the bonding layer 312, the touchpad device 300 can respond better to vertical vibrations in deformation to achieve the effect of strengthening the vertical vibration haptics.

In several embodiments, the dimensions and materials of the bonding layer 312 are the same as those of the embodiment described in FIG. 2. Therefore, relevant explanations of these components can be referenced in the aforementioned descriptions and will not be repeated here.

In several embodiments, the feedback assembly 330 is a linear resonant actuator (LRA). However, the present disclosure is not limited thereto. In several embodiments, the feedback assembly 330 may comprise a coil layer 213b disposed on the circuit board 213, and a magnet set 222 disposed on the supporting member 221, as shown in the embodiment of FIG. 2. In other words, the composite of the circuit board 313 and the feedback assembly 330 of this embodiment is interchangeable with the composite of the circuit board 213, the coil layer 213b, and the magnet set 222 of the embodiment of FIG. 2. Therefore, the specific implementation of the aforementioned composite of the circuit board 213, the coil layer 213b, and the magnet set 222 may be implemented in the touchpad device 300 of this embodiment, and therefore will not be further discussed here.

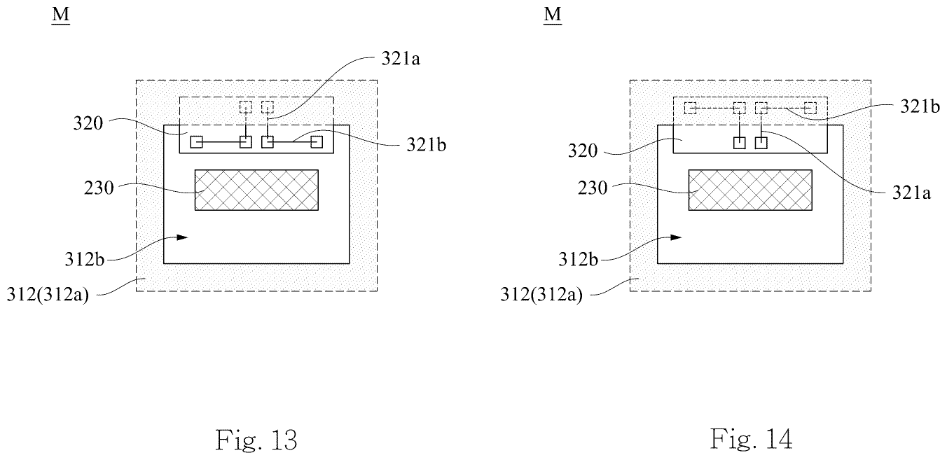

Please refer to FIG. 13 and FIG. 14. FIG. 13 is an enlarged schematic figure of the area M of FIG. 12. FIG. 14 is an enlarged schematic figure of the area M of FIG. 12 of another embodiment. As illustrated in FIG. 13 and FIG. 14, each of the force sensing units 320 comprises a plurality of strain electrodes 321a and a plurality of temperature compensation electrodes 321b adjacent to each other. The strain electrodes 321a are disposed corresponding to the bonding portion 312a and the hollow portion 312b at the same time in the arrangement direction D of the cover plate 211 and the bonding layer 312. In other words, the strain electrodes 321a are disposed across the bottom parts of the bonding portion 312a and the hollow portion 312b at the same time. Through such a configuration, the deformation amount of the strain electrodes 321a when the cover plate 211 of the touchpad device 300 is pressed will increase, leading to an increase in sensitivity.

In the embodiment as shown in FIG. 13, the temperature compensation electrodes 321b are disposed corresponding to the hollow portion 312b in the arrangement direction D of the cover plate 211 and the bonding layer 312. In other words, the temperature compensation electrodes 321b are completely located under the hollow portions 312b without crossing the bottom parts of the bonding portion 312a. In the embodiment as shown in FIG. 14, the temperature compensation electrodes 321b are disposed corresponding to the bonding portion 312a in an arrangement direction D of the cover plate 211 and the bonding layer 312. In other words, the temperature compensation electrodes 321b are completely located under the bonding portion 312a without crossing to the bottom parts of the hollow portion 312b. Through such a configuration, strain that occurs in the temperature compensation electrodes 321b can be prevented, so that temperature changes can be precisely obtained for reference.

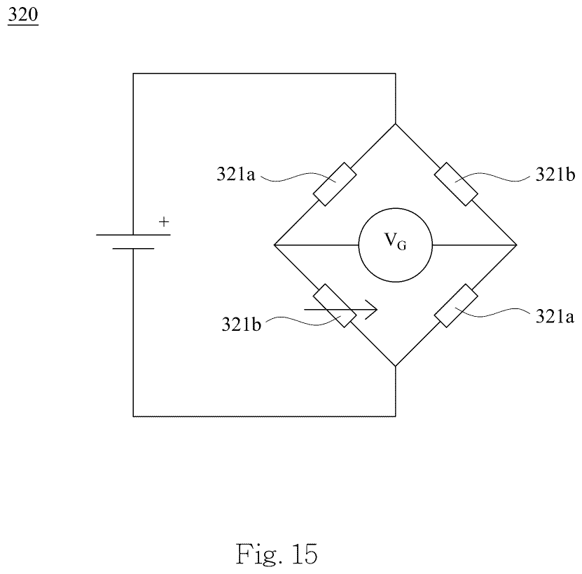

Please refer to FIG. 15, which is the circuit schematic of a force sensing unit 320 of FIG. 12. In the embodiment, the strain electrodes 321a and the temperature compensation electrodes 321b of the force sensing unit 320 form a bridge circuit of a Wheatstone bridge as illustrated in FIG. 15. However, the present disclosure is not limited thereto. The main function of the strain electrode 321a is to sense the pressure change. The temperature compensation electrode 321b functions as a temperature compensation electrode of the strain electrode 321a while compensating for the temperature change, so that the Wheatstone bridge can achieve a bridge balance during temperature changes.

In several embodiments, as shown in FIG. 12, the hollow portions 312b are disposed corresponding to the force sensing unit 320, respectively, in the arrangement direction D of the cover plate 211 and the bonding layer 312. In other words, the quantity of the hollow portions 312b is the same as that of the force sensing units 320. In several embodiments, each of the hollow portions 312b is disposed corresponding to a plurality of force sensing units 320 in an arrangement direction D. For example, the bonding layer 312 shown in FIG. 12 may be modified according to the configuration in FIG. 3 to have two hollow portions 312b disposed at the upper and lower positions respectively, and each of the hollow portions 312b is disposed corresponding to four force sensing units 320 in the arrangement direction D. In the specific implementation, the number of force sensing units 320, which each of the hollow portions 312b is corresponding to in the arrangement direction D, may be adjusted flexibly. For example, the bonding layer 312 may also only have one hollow portion 312b corresponding to all force sensing units in the arrangement direction D at the same time.

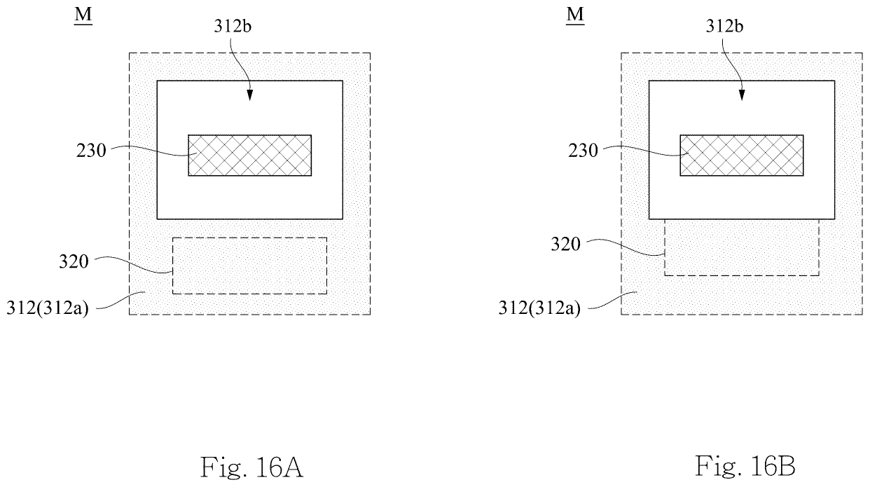

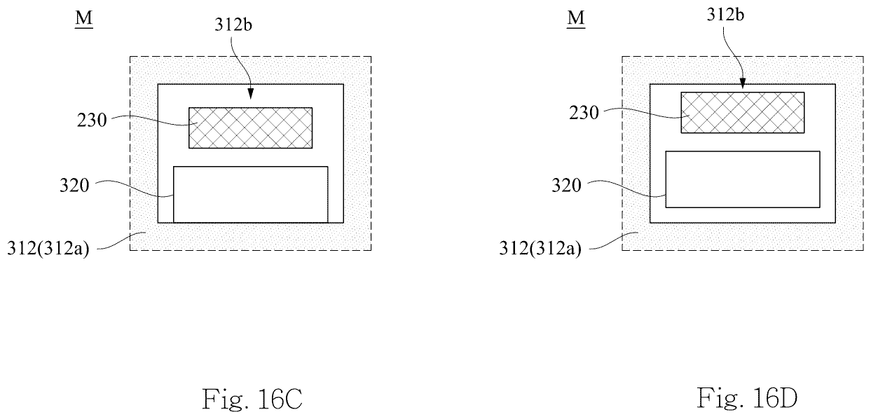

Please refer to FIG. 16A, FIG. 16B, FIG. 16C, and FIG. 16D, which are enlarged schematic figures of the area M of FIG. 12 of the first comparative example, the second comparative example, the third comparative example, and the fourth comparative example, respectively. In the first comparative example, as illustrated in FIG. 16A, the force sensing unit 320 is located entirely under the bonding portion 312a in the arrangement direction D of the cover plate 211 and the bonding portion 312a, and is separate from the hollow portion 312b. In the second comparative example, the force sensing unit 320 is located entirely under the bonding portion 312a in the arrangement direction D, and is aligned with the boundary between the hollow portion 312b and the bonding portion 312a. In the third comparative example, the force sensing unit 320 is located entirely under the hollow portion 312b in the arrangement direction D, and is aligned with the boundary between the hollow portion 312b and the bonding portion 312a. In the fourth comparative example, the force sensing unit 320 is located entirely under the hollow portion 312b in the arrangement direction D of the cover plate 211 and the bonding layer 312, and the force sensing unit 320 is separate from the bonding portion 312a. Thus, it can be known that in the first comparative example, the second comparative example, the third comparative example, and the fourth comparative example, the force sensing unit 320 is not disposed across the bonding portion 312a and the hollow portion 312b.

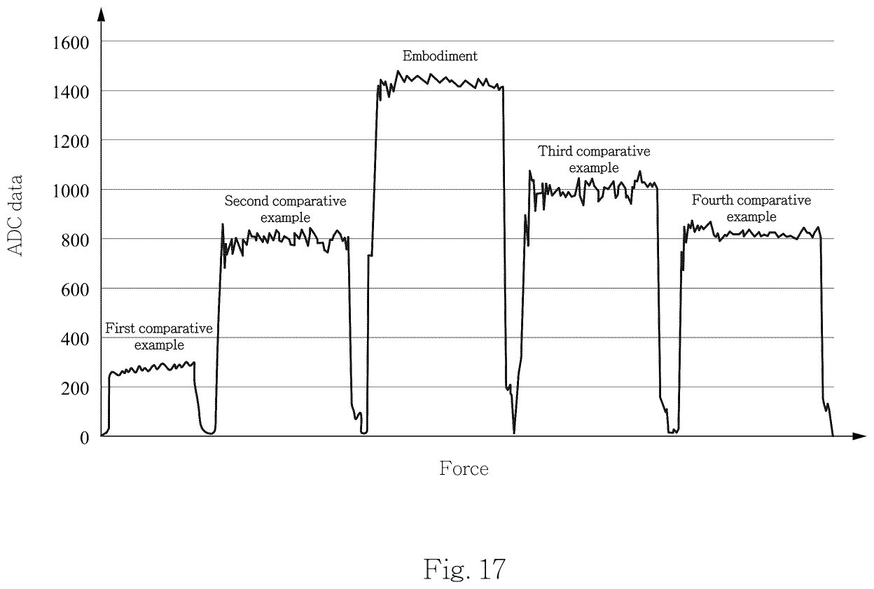

Please refer to FIG. 17, which is a pressure output signal figure of the touchpad device 300 having the designs of the embodiment example of FIG. 13, the first comparative example, the second comparative example, the third comparative example, and the fourth comparative example, respectively. FIG. 17 illustrates a pressure output signal produced by applying a force of 150g to press on the cover plate 211 of the touchpad device 300. As shown in FIG. 17, the signal strength of the first comparative example is the smallest, while the signal strength of the embodiment example of FIG. 13 is the largest; whereas the signal strengths of the second comparative example, the third comparative example, and the fourth comparative example fall within the range between the smallest and the largest scales. Thus, it can be known that by configuring the strain electrodes 321a to correspond the bonding portion 312a of the bonding layer 312 and the hollow portion 312b in the arrangement direction D of the cover plate 211 and the bonding layer 312 (that is, across the bonding portion 312a and the hollow portion 312b), the deformation amount of the strain electrodes 321a is confirmed to increase when the cover plate 211 of the touchpad device 300 is pressed, leading to an increase in sensitivity.

According to the descriptions of specific embodiments of the present disclosure, it is apparent that, in the touchpad device of the present disclosure, since the force sensing units comprise the strain electrodes and the temperature compensation electrodes at the same time, the touchpad device possesses a built-in temperature compensation function that can solve the detection bias caused by the heat effect. By means of having the strain electrodes disposed corresponding to the bonding portion of the bonding layer and the hollow portion in an arrangement direction of the cover plate and the bonding layer (that is, across the bonding portion and the hollow portion), the deformation amount of the strain electrodes can increase when the cover plate of the touchpad device is pressed, leading to an significant increase in sensitivity. By means of having the temperature compensation electrodes disposed corresponding to the bonding portion or the hollow portion in an arrangement direction of the cover plate and the bonding layer (that is, not across the bonding portion and the hollow portion), strain may be prevented, so that temperature changes can be precisely obtained for reference.

The above preferred embodiments are presented to disclose the present disclosure and shall not be interpreted to limit the scope, applicability, or configuration of the present disclosure in any way. Those skilled in the art may use any alternative embodiments that are modified or changed without departing from the spirit and scope of the present disclosure. Thus, the protection scope of the present disclosure shall be included in the appended claims.

### COMPONENT SYMBOL

100: Electronic device
110: Host computer
111: Casing part
111a: Recessed groove
120: Monitor
200, 300: Touchpad device
210: First assembly
211: Cover plate
211a: Bonding area
211b: Non-bonding area
212, 312: Bonding layer
212a, 312a: Bonding portion
212b, 312b: Hollow portion
213, 313: Circuit board
213a: Touch sensing member
213a1: First touch electrode layer
213a2: Second touch electrode layer
213a3: Processing unit
213b: Coil layer
213b1: First coil unit
213b11, 213b12, 213b21, 213b22: Straight coil bundle section
213b2: Second coil unit
213c: Shielding layer
213d: Insulating layer
213e: Solder mask layer
213f: Nickel layer
213g: Metal layer
213h: Cover layer
214: Force sensor
220: Second assembly
221: Supporting member
222, 322: Magnet set
222a, 322a: First magnet
222b, 322b: Second magnet
222c: Third magnet
230: Elastic member
313a: First surface
313b: Second surface
320: Force sensing units
321a: Strain electrode
321b: Temperature compensation electrode
330: Feedback assembly
A1: First sensing area
A2: Second sensing area
D: Arrangement direction
G: Gap
M: Area
P: Coil distance
S1, S2: Distance
T: Thickness
W: Width

What is claimed is:

1. A touchpad device, comprising
a cover plate;
a circuit board, disposed under the cover plate and comprising a first surface facing the cover plate and a second surface away from the cover plate;
a bonding layer, disposed between the cover plate and the first surface, and comprising a bonding portion and at least one hollow portion;
a plurality of force sensing units, disposed on the second surface with each of the force sensing units comprising a plurality of strain electrodes and a plurality of temperature compensation electrodes adjacent to each other, wherein the strain electrodes are disposed corresponding to the bonding portion and the at least one hollow portion at a same time in an arrangement direction of the cover plate and the bonding layer, and the temperature compensation electrodes are disposed corresponding to one of the bonding portion or the at least one hollow portion in the arrangement direction; and
a feedback assembly, disposed on the second surface and configured to provide tactile feedback.

2. The touchpad device of claim 1, wherein the at least one hollow portion is a closed slot.

3. The touchpad device of claim 1, wherein a quantity of the at least one hollow portion is a plurality, and the hollow portions are disposed corresponding to the force sensing units in the arrangement direction, respectively.

4. The touchpad device of claim 1, wherein a quantity of the at least one hollow portion is a plurality, and each of the hollow portions is disposed corresponding to a plurality of the force sensing units in the arrangement direction.

5. The touchpad device of claim 1, further comprising:
a supporting member, disposed under the circuit board; and
a plurality of elastic members, disposed between the circuit board and the supporting member.

6. The touchpad device of claim 5, wherein the elastic members are disposed corresponding to the at least one hollow portion in the arrangement direction.

7. The touchpad device of claim 5, wherein the feedback assembly comprises a coil layer and a magnet set.

8. The touchpad device of claim 7, wherein the coil layer is disposed on the circuit board, and the magnet set is disposed on the supporting member.

9. The touchpad device of claim 1, wherein the feedback assembly is a linear resonant actuator.

10. The touchpad device of claim 1, wherein the strain electrodes and the temperature compensation electrodes of each of the force sensing units form a bridge circuit.
